(19) United States
(12) Patent Application Publication
(10) Pub. No.: US 2015/0002932 A1
(43) Pub. Date: Jan. 1, 2015

(54) LENTICULAR SHEET FOR CREATING AN OPTICAL STEREO EFFECT OF AN IMAGE CODED IN A DECORATIVE PANEL AND A METHOD OF CARRYING OUT THE SAME

(71) Applicants: Denys Bityutskyy, Donetsk (UA); Andrii Karlov, Donetska Obl. (UA); Ievegen Viunskovskyi, Donetska obl. (UA); Roman Kulniev, Donetska obl. (UA)

(72) Inventors: Denys Bityutskyy, Donetsk (UA); Andrii Karlov, Donetska Obl. (UA); Ievegen Viunskovskyi, Donetska obl. (UA); Roman Kulniev, Donetska obl. (UA)

(21) Appl. No.: 14/375,495

(22) PCT Filed: Jan. 31, 2013
(86) PCT No.: PCT/UA2013/000016

§ 371 Date: Jul. 30, 2014

(30) Foreign Application Priority Data
Jan. 31, 2012 (LU) 91938

(51) Int. Cl. G02B 27/22; C03C 21/00; C03B 13/08; C03B 27/04; G02B 3/00; G02B 1/00

(52) U.S. Cl. CPC G02B 27/2214; G02B 3/0031; G02B 1/00; G02B 3/005; C03B 13/08; C03B 27/0413; C03C 21/002; C03B 2215/414
USPC 359/463; 65/97; 65/95; 65/30.14

(57) ABSTRACT

Invention relates to lenticular sheets made of thermally or chemically hardened mineral glass used for decorative panels, to create three-dimensional visual effects combined with an encoded image. One of the advantages of invention is the fact that it is a proposed mineral lenticular sheet, which underwent chemical or mechanical hardening of its outer parts 18. This increases the mechanical strength and impact resistance. This aspect makes it safer for use under the influence of external factors and in contact with a person. This allows for applying the invention in large scopes in comparison with plastic lenticular screens. Pre-stressing is achieved by thermal or chemical hardening.

### RELATED

This application claims the priority filing date of international application no. PCT/UA2013/000016 filed on Jan. 31, 2013, and published on Aug. 8, 2013. The earliest priority filing date claimed is Jan. 31, 2012.

### FIELD OF THE INVENTION

The invention is related to a decorative panel with an optical effect and more particularly to a translucent lenticular sheet made of mineral material with ability to create an optical stereo effect of an image coded therein and a method of carrying out the same.

### BACKGROUND ART

It is known from the prior art (US 2006/0082880 A1, U.S. Pat. No. 5,681,676 and U.S. Pat. No. 6,795,241) the decorative panels with effects of recording and playing back encoded three-dimensional image of the object. Lenticular sheets of such known panels are made of PMMA, plastics, polyethylene and polyethylene terephthalate. When in service of the decorative panels the resistance to external influences of material to be used plays an special role. In contrast to using plastic materials (plastics) for lenticular sheet of similar surface topography (cylindrical lenses) it is proposed, according to the invention, to use mineral glass inasmuch as mineral glass is the most resilient to external shocks due to the fact that during thermal or chemical treatment of mineral lenticular sheet its resistance to external influences increases dramatically. In the preferable embodiments it may be used heat-resistant and tempered mineral glass. In comparison with a plastic lenticular sheet the lenticular sheet made from a mineral glass allows to increase possible fields of using such decorative panel and the duration of its operational period under constant influence of external factors.

Thus mechanical damage (scratches) creates areas preventing penetration and refraction of light, which leads to lenticular opacities and image distortion. This can be seen in plastics. On mineral lenticular sheet the same can be observed after much longer period of time.

Mineral lenticular sheet is also more secure than plastic after faults. Hardened mineral material with mechanical failure constitutes a lot of small pieces without sharp edges, which is not true for plastics, especially at low temperatures. Thus, mineral material of a lenticular sheet allows to create a decorative panel with a long service life.

Another important advantage of the claimed invention compared to a lenticular sheet of the prior art is its resistance to temperature changes. One of the main materials used to manufacture lenticular screen is plastic, which as well as any plastic material, is subject to thermal expansion to a greater extent than mineral material. This feature requires special technical solutions in the design, especially in the large flat surfaces. Linear coefficient of thermal expansion of the glass is 0.8×10⁻⁵, which is by more than eight times lower than the linear coefficient of thermal expansion of plastics—6.5×10⁻⁵. This fact is important for aesthetics and ease of installation of the decorative panel having a lenticular sheet according to the invention. That is the linear coefficient of thermal expansion of the glass—0.8×10⁻⁵ that enables to keep the joints between the panels of 1-2 mm, while with plastic panels the size of the joint makes between 9-10 mm. ^{[2]}The tolerance to be envisaged for thermal expansion in the length and width of the sheet is easily calculated:

ΔL=β×L×ΔT

Where β—coefficient of linear thermal expansion;
L—length of sheet;

ΔT—application temperature range. Plastic is also exposed to ultraviolet radiation. This radiation causes yellowing of the material over time. This change alters the quality of the image and reduces contrast.

Plastic, unlike mineral material has another negative feature i.e. hygroscopicity and high permeability to gases and vapors. This imposes a number of technological limitations on the use of this material. The moisture that gets under the plastic can be absorbed from the back of the sheet (usually the outer surface is tightened with vinyl film and is not hygroscopic). Then, in some time, with the change of humidity and/or temperature, the accumulated moisture can come back to both surfaces, including those on the outside.

Another disadvantage of plastic is that after a while it turns yellow when exposed to ultraviolet rays. By the nature, plastic is not resistant to UV rays. In a few years plastic with no special protection (UV stabilizers in the structure or the protective layer on the surface) becomes unfit for further use. The destructive effect of the sun will be especially noticeable in a transparent and milky-white material. Yellowing and opacification will cause significant reduction of light transmission and loss of visual effect. The like sheets with no any protection are only suitable for indoor use. Mineral material used in the present invention is not exposed to UV radiation, which greatly extends the scope of the invention.

Another advantage of the top layer of the invention is its high melting point—1450° C., while melting point of plastic is 250° C., as one of the main materials used for the manufacture of lenticular, and its softening temperature is 145° C. This advantage extends the field of using the invention and makes it more practical when exposed to high temperatures.

Plastic screen is resistant to most chemicals, but still when contacting the surface of the screen, the chemicals cause its destruction. In areas where surface of plastic screen undergone chemical exposure there could appear cracks that change color, opacity, etc. The resulting cracks (visible only under a microscope) may contribute to the formation of deeper cracks at fixing or bending the sheet (i.e. in places where plastic fiber is under stress). Plastic screen should be protected from ingress of aggressive chemicals such as acetone, ketone, various esters, hydrocarbon flavored and chlorinated, alcohol and alkali based detergents, ammonia, various amines.

Another advantage of the invention is the fact that outer layer of mineral material, takes care of all the effects of the environment. This cover protects the panel from mechanical loads, ensures resistance to aggressive environments (most acid and alkali), organic solvents, moisture, temperature extremes (with a wider range than that of plastics) and ultraviolet rays.

The advantages of the invention may also include the ease of installation. The panels are attached to the surface in the same manner as tile.

### SUMMARY OF THE INVENTION

The invention is created to solve the technical problems issues raised above. The invention is aimed at improving the durability of lenticular sheet, preserving its optical properties, increasing its mechanical strength and reducing danger caused by lenticular sheet in case of destruction of the panel. The invention is also aimed to broaden the field of using of a lenticular sheet.

The invention relates to a lenticular sheet, which can create an optical effect in combination with encoded image. Being transparent lenticular sheet consists of one flat surface and another surface with a number of lenses, wherein the lenticular sheet is made of mineral glass.

The invention also relates to a method of production of lenticular inorganic glass sheets with a lot of cylindrical lenses arranged parallel to each other. The process of manufacture includes the following stages:

a) glass melting;
b) rolling of glass between rollers; this stage is remarkable by the fact that one of the rollers has negative surface cylindrical lens to form a cylindrical lenses.

Also the claimed method includes the stage of thermal or chemical hardening of the glass and applying of the coded image on mineral lenticular sheet. As it had been stated herein mineral material is more resistant to a variety of external factors.

Mineral material provides resistance to chemicals and UV radiation. Chemical or thermal hardening improves mechanical properties. This prevents the emergence and propagation of cracks, increases crashworthiness and resistance to external factors. These aspects help to keep the optical feature of the lenticular sheet over time.

Chemical hardening can be used for lenticular sheet with a thickness of less than or equal to 3.00 mm. The strength of a given thickness of the lenticular sheet made of hardened inorganic material is much higher than of plastic one. In case of very strong shocks, which cause the breakdown of lenticular sheet, the debris of mineral lenticular sheet pose less danger to people.

### BRIEF DESCRIPTION OF THE DRAWINGS

Essence of the invention and its advantages will become clear by the detailed description of the invention with references to the drawings, in which:

FIG. 1 shows part of a panel with a lenticular sheet of the present invention;

FIG. 2 shows the internal stress of hardened mineral lenticular sheet;

FIG. 3 shows a diagram of the process of production of mineral lenticular sheet in accordance with the invention.

### BEST MODE FOR CARRYING OUT THE INVENTION

Lenticular panel 2, as shown in FIG. 1, is used to create the perceived optical stereo effect and is attractive for advertising and/or as a decorative facing material. Perceived image changes depending on the viewing angle of the observer. Following type of lenticular panel 2, the observer can see the alteration of multiple images changing the position or have the impression of depth, which is known as three-dimensional image. This optical effect corresponds to the method developed by Gabriel Lippmann.

Lenticular panel 2 contains lens 4, also known as mineral lenticular sheet 4, which is connected with the encoded image 6. Lens 4 has one flat surface to be coated with encoded image 6, while the second front surface accommodates in-parallel placed cylindrical lenses 8 (lines 14 being parallel each other). Cylindrical lenses 8 are parallel and they form parts of the cylinder. Cylindrical lenses 8 can be in the form of a semi-cylinder or less of the tube cut to length from the center of the cylinder. Encoded image 6 can be applied directly to the lower part of the lens 4 with a special printer or printed on an additional medium (paper, film) and connected to the lens 4. Encoded image 6 is generated using special software. Due to the location of cylindrical lenses 8 forms, the perception of specially encoded image varies depending on the lateral position of the observer in relation to the lenticular panel.

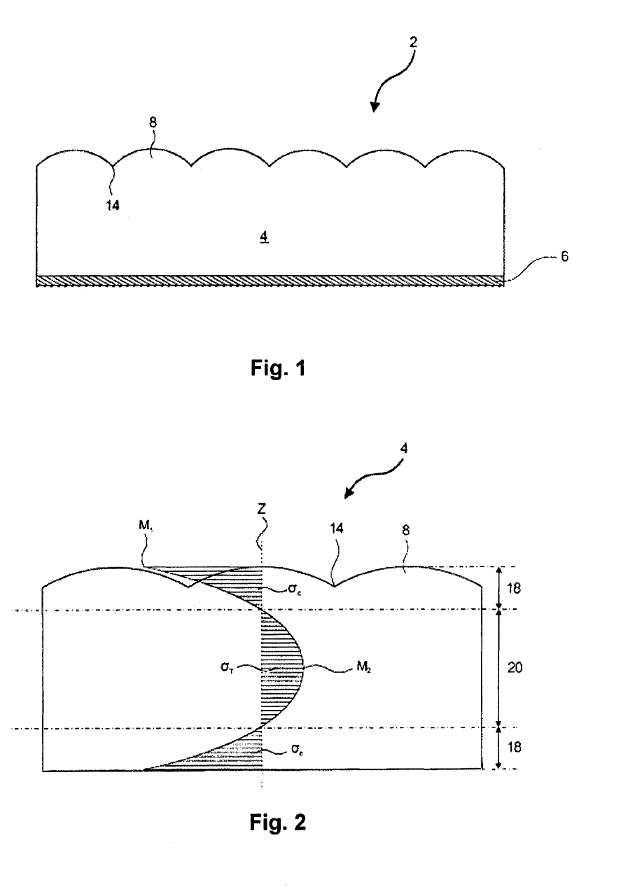

FIG. 2 shows schematically the lenses 4, where one of the surfaces has cylindrical lenses.

Mineral material can be used due to its resistance to chemicals, mechanical strength and UV radiation. The hardness of the glass surface is resistant to scratches. The geometry of the lenticular sheet 4 is based on the shape of a cylinder, its thickness, its refractive index, preferred distance, at which the desired optical effect is to be observed. The geometry of the lenticular sheet is known in the art. The thickness of lens 4 sheet is more or equal to 1.00 mm.

FIG. 2 shows schematic bias of stress along axis Z through the lenticular sheet in its thickness. FIG. 2 shows formation of cylinder parts less than half of the cylinder in size. The specialist in this field of technic allows him imaging the prestress equivalent to lenticular sheet with a cylindrical lens. The prestress changes in the thickness of the lens sheet. The value of prestressing is symmetric with respect to the median plane of the lenticular sheet. The center of stressing is parallel to the plane and is in the middle, between two surfaces. Stressing distribution dissymmetry can be observed in the presence of the lens.

The thickness of the lenticular sheet includes first layer 18 on the first planar surface and second layer 18 on the second surface, which accommodates parts of parallel cylinders. Both outer layers 18 determine the central layer 20. Layers 18 and central layer 20 are formed in the thickness of the lens sheet and are generally parallel. These layers vary in prestress. One can see that the bias at the junction of these layers equals to zero.

Layers 18 have prestress same in both layers when the lenticular sheet 4 is free from external mechanical influences. Prestressing in layers 18 is compression stress σ_{c}. The accumulation of each compressive stress σ_{c} varies in thickness of the layers, and represents the first maximum M1 towards each outer surface.

The central part 20 shows prestressing σ_{T}, which is tensile stress σ_{T}. Tensile stress σ_{T} changes in the thickness of the lens sheet. The stress is the second maximum M2, which is in the middle of its thickness. The accumulation of tensile stress increases the tension. We emphasize that the strength of compression stress σ_{c} is equal to tensile stress σ_{T}, which comes out of the mechanical equilibrium of lenticular sheet 4.

The sum of compression stress areas is equal to the area of tensile stress along diagram contour—FIG. 2.

In case of bending the lenticular sheet 4, one layer is for compression and the other one for tension. Thus, the stress across the border of the stretch is equal to the first maximum M1. Resistance with scratches also improved. It should be borne in mind that hardening of mineral lenticular sheet will extend the life of the material 4. The lenses are resistant to the environment without compromising strength. These qualities help to keep the optical quality of the lenses 4 of lenticular sheet over time.

Lenticular sheet acquires its mechanical and optical properties during production cycle of the invention, which gives it its shape and stresses. Resistance can also be achieved by chemical hardening. Having formed lens 4 sheet, it is immersed in a bath having a temperature between 350° C. and 450° C. to expand. The bath includes a solution of potassium salts. Due to the heat, the sodium ions on the surface of the lens 4 sheet migrate into the bath and are replaced by potassium ions present in the bath. Let us stress on the fact that there are more potassium ions than sodium ions. Chemical hardening increases the impact strength. This is especially useful for hardening lenticular sheet 4 with a total thickness of less than 3 mm.

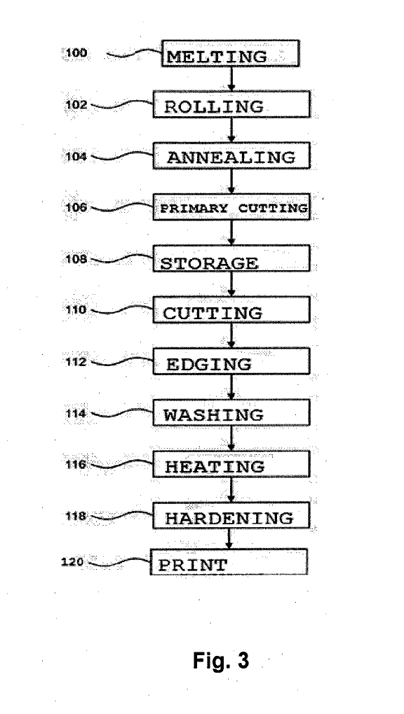

For lenticular sheet 4 with thickness more than than 3 mm one may apply another method i.e. thermal hardening. This process is shown in FIG. 3, which also shows the formation of lenticular sheet 4.

The method comprises the step 100 of glass melting. The material is brought to the melting temperature in a furnace. The temperature is adjustable from 1500° C. to 1600° C. to remove impurities and gas bubbles, which could affect the optical characteristics of the glass. Then begins the rolling step 102 where melted mineral glass passes between the rolls. Rollers are positioned perpendicular to the direction of the melt flow. The shafts are parallel; the distance between them allows for the necessary thickness of lenticular sheet 4. One of the rollers has negative cylindrical lens surface, forming cylindrical lenses 8, which are desired to be acquired in the final product. This phase of rolling finalizes the form of the glass. Then, begins the annealing step 104, when mineral material is slowly cooled to a temperature between 275° C. and 225° C. Then, mineral material is cooled in the open air at a temperature of 10° C. to 30° C.

Next stage should be primary cutting step 106 and storage step 108 for easy storage and handling. After that, mineral material acquires the final form. The second part can change its mechanical properties as a result of thermal or chemical hardening.

The second part of the process begins with a step 110 of second cutting lenses by their sizes to be used. This size can be more than 1 m long and 1 m wide.

The next step 112 is formation of edge contour, change of fields to drill lens sheet. Then the glass is cleaned up by step 114.

The next step 116 is heating, where the temperature is brought to 550° C. and 750° C. Under the given temperature range, mineral material is flexible and can be deformable. Immediately after this step starts a sheet hardening 118. Lens sheet is exposed to air stream reducing temperature from 550° C. to less than 350° C. for 10 seconds. Air streams are directed to the sheet from two sides. Thus the lenticular sheet is hardened. At this stage hardening is complete and the temperature is brought to room rate. It is noted that step 110 of cutting 110 and step 112 formation are executed before hardening step 118 as once the last stage is over mineral material is not subject to processing.

Thermal stages are necessary to change the state of the sheet as a result of hard collision and destruction of lenticular panel. In case of destruction of lenticular sheet there appear small fragments, the size of which is similar to the thickness of the lenticular sheet.

According to the alternative way of hardening, mineral material is cooled in the range between 550° C. and 300° C. for more than 10 seconds, namely for more than 600 seconds. This option allows you further increasing the tensile strength of the glass. Flexural strength at break may be greater than 120 N/mm2.

According to another embodiment of the invention, certain stages of the invention may be omitted. In particular, the method can proceed to stage 104 and cutting stage 110.

1. A lenticular sheet (4) for creating in a decorative panel an optical stereo effect of an image (6) coded therein , including a transparent flat surface on one side and a plurality of cylindrical lenses arranged parallel to each other on the other side wherein the lenticular sheet (4) is made of mineral glass.

2. The lenticular sheet according to claim 1, wherein the mineral lenticular sheet (4) is finished by thermal or chemical hardening.

4. A method of producing mineral lenticular sheet (4) according to claim (1) , comprising the following steps:
a) glass melting (100)
b) forming a sheet (4) by rolling (104) of the melted glass (104) between two shafts, wherein one of the shafts has a flat surface, while another has negative forms of lenses, thus forming a plurality of cylindrical lenses arranged in parallel to each other on the other side of the sheet (4).
c) primary cutting subject to proportions of the decorative panel used therein.

3. The method according to claim 2 wherein further chemical or thermal hardening is provided after step (b) depending on the required thinkness of the sheet (4).

4. The method according to claim 3 wherein for the sheet having thinkness less than 3 mm a chemical hardening is provided preferably by immersing the sheet in a bath including a solution of potassium salts.

5. The method according to claim 3 wherein for the sheet having thickness more than 3 mm a thermal hardening is provided preferably by cooling in the range between approximately 550° C. and 300° C. for a time within the range between approximately 10-600 seconds.

6. The method according to claim 5, wherein a sequence of steps consisting of edging (110), washing (114), heating (116) is further provided after step (before step (118) of thermal hardening.
